(19) United States
(12) Patent Application Publication
(10) Pub. No.: US 2025/0012398 A1
(43) Pub. Date: Jan. 9, 2025

(54) VACUUM INSULATION PANEL

(71) Applicant: SAMSUNG ELECTRONICS CO., LTD., Suwon-si (KR)

(72) Inventors: Sunghwan HONG, Suwon-si (KR); Jungsoo Lim, Suwon-si (KR); Yeonkyoung Jung, Suwon-si (KR)

(73) Assignee: SAMSUNG ELECTRONICS CO., LTD., Suwon-si (KR)

(21) Appl. No.: 18/653,554

(22) Filed: May 2, 2024

Related U.S. Application Data
(63) Continuation of application No. PCT/KR2024/005051, filed on Apr. 16, 2024.

(30) Foreign Application Priority Data
Jul. 3, 2023 (KR) 10-2023-0086104
Aug. 29, 2023 (KR) 10-2023-0114048

(51) Int. Cl. F16L 59/065

(52) U.S. Cl. CPC F16L 59/065

(57) ABSTRACT

Provided is a vacuum insulation panel including a core material and a covering material on an outer side of the core material. The covering material forms an internal space in which the core material is accommodated, wherein the core material includes a first plate in the internal space and having a first thickness. The core material includes a second plate in the internal space, spaced from the first plate, and has the first thickness. The core material includes one supporting member between the first plate and the second plate and having a second thickness that is greater than the first thickness, wherein each of a surface of the first plate that is perpendicular to a thickness direction of the core material and a surface of the second plate that is perpendicular to the thickness direction has a first area.

### CROSS-REFERENCE TO RELATED APPLICATIONS

This application is a bypass continuation of International Application No. PCT/KR2024/005051, filed on Apr. 16, 2024, which is based on and claims priority to Korean Patent Application No. 10-2023-0086104, filed on Jul. 3, 2023, in the Korean Intellectual Property Office, and Korean Patent Application No. 10-2023-0114048, filed on Aug. 29, 2023, in the Korean Intellectual Property Office, the disclosures of which are incorporated by reference herein in their entireties.

### BACKGROUND

### 1. Field

The disclosure relates to a vacuum insulation panel.

### 2. Description of Related Art

Insulation materials are used to keep things warm or block heat. For example, insulation materials are used in refrigerators to insulate the insides of the storage rooms of the refrigerators from the outside.

Polyurethane foam may be used as an insulation material in refrigerators. Vacuum insulation panels having lower thermal conductivity than polyurethane foam in refrigerators are being made. Vacuum insulation panels used in refrigerators reduce the wall thicknesses of the refrigerators and increase the effective capacities of the refrigerators.

However, the vacuum insulation panels used to reduce the wall thicknesses of the refrigerators may cause structural instability of the walls of the refrigerators because the density of the vacuum insulation panels is higher than that of polyurethane foam.

### SUMMARY

Provided is a vacuum insulation panel structured to reduce a density.

An aspect of the disclosure provides a vacuum insulation panel with improved insulation performance due to low thermal conductivity.

An aspect of the disclosure provides a vacuum insulation panel capable of maintaining flatness and structure even at a pressure of 6 atmospheres.

Technical aspects intended to be achieved by the one or more embodiments are not limited to the above-mentioned technical objects, and other technical objects not mentioned will be clearly understood by one of ordinary skill in the technical art to which the disclosure belongs from the following description.

According to an aspect of the disclosure, there is provided vacuum insulation panel including: a core material; and a covering material on an outer side of the core material and forming an internal space in which the core material is accommodated, wherein the core material includes: a first plate in the internal space and having a first thickness, the first plate including a first porous material with a Young's modulus of at least 30 megapascals (MPa); a second plate in the internal space, spaced from the first plate, and having the first thickness, the second plate including a second porous material with a Young's modulus of at least 30 MPa; and at least one supporting member between the first plate and the second plate and having a second thickness that is greater than the first thickness, the at least one supporting member including a third porous material with a Young's modulus of at least 30 MPa, wherein each of a surface of the first plate that is perpendicular to a thickness direction of the core material and a surface of the second plate that is perpendicular to the thickness direction has a first area, and wherein a surface of the at least one supporting member that is perpendicular to the thickness direction has a second area that is smaller than the first area.

The first thickness may be a, the second thickness may be b, and the first thickness and the second thickness may satisfy (2a+b)*85%≤b≤ (2a+b)*92.0%.

The first area may be S1, the second area may be S2, and the first area and the second area may satisfy S1*5.64%≤S2≤S1*11.60%.

A density of the core material may be less than 40 kg/m3.

The at least one supporting member may include a plurality of supporting members, and each of the plurality of supporting members may have a shape of a cylinder with a radius of r.

A minimum distance between centers of two supporting members positioned adjacent to each other among the plurality of supporting members may be d and satisfies 5.20*r≤d≤7.46*r.

A maximum distance between centers of two supporting members positioned adjacent to each other among the plurality of supporting members may be L and satisfies 0.12≤r/L≤0.19.

While a pressure of 6 atmospheres (atm) may be applied to the first plate or the second plate, a maximum beam deflection of the first plate or the second plate may be less than or equal to 0.5 mm.

The supporting member may be in a shape of a polyprism, wherein an area of a polygon that is a cross section of the polyprism may be π*r\hat{ }2, and wherein a maximum distance of an edge of the polygon from a center of the polygon may be r.

At least two of the first plate, the second plate, and the at least one supporting member may include a same material.

Each of the first plate, the second plate, and the at least one supporting member may include at least one of glass wool, expanded cork, or polyurethane.

The internal space may be in a vacuum state.

According to an aspect of the disclosure, there is provided an insulation panel including: a core structure including: a first plate having a first thickness, the first plate including a first porous material; a second plate having the first thickness, the second plate including a second porous material; and a plurality of supporting members spaced apart from each other and interposed between the first plate and the second plate, the plurality of supporting members having a second thickness that is greater than the first thickness and including a third porous material; and a cover surrounding the core structure in a vacuum state, and wherein each of a surface of the first plate that is perpendicular to a thickness direction of the core structure and a surface of the second plate that is perpendicular to the thickness direction has a first area, and a surface of the supporting member that is perpendicular to the thickness direction has a second area that is smaller than the first area.

The cover includes a film that blocks moisture and gas.

Each of the first porous material, the second porous material, and the third porous material may have a Young's modulus of at least 30 megapascals (MPa).

Each of the first porous material, the second porous material, and the third porous material may have a Young's modulus of at least 40 megapascals (MPa).

Each of the first porous material, the second porous material, and the third porous material may have a Young's modulus of at least 50 megapascals (MPa).

Each of the first porous material, the second porous material, and the third porous material may have a Young's modulus of at least 60 megapascals (MPa).

Each of the first porous material, the second porous material, and the third porous material may have a Young's modulus of at least 70 megapascals (MPa).

Each of the first porous material, the second porous material, and the third porous material may have a Young's modulus of at least 80 megapascals (MPa).

According to an aspect of the disclosure, there is provided a vacuum insulation panel structured to reduce a density.

According to an aspect of the disclosure, there is provided a vacuum insulation panel with improved insulation performance due to low thermal conductivity.

According to an aspect of the disclosure, there is provided a vacuum insulation panel capable of maintaining flatness and structure even at a pressure of 6 atmospheres.

### BRIEF DESCRIPTION OF THE DRAWINGS

The above and other aspects, features, and/or advantages of certain embodiments of the disclosure will be more apparent from the following description taken in conjunction with the accompanying drawings, in which:

FIG. 1 illustrates a vacuum insulation panel according to an embodiment;

FIG. 2 illustrates a cross section of a vacuum insulation panel according to an embodiment;

FIG. 3 illustrates an example of a core material of a vacuum insulation panel according to an embodiment;

FIG. 4 illustrates a supporting member and a second plate in the core material shown in FIG. 3, at another angle;

FIG. 5 conceptually illustrates beam deflection of a first plate while a pressure is applied to a core material of a vacuum insulation panel according to an embodiment;

FIG. 6 is a table of structures of a core material of a vacuum insulation panel according to an embodiment, illustrating data under a condition that a Young's modulus of the core material is 30 MPa;

FIG. 7 is a table of structures of a core material of a vacuum insulation panel according to an embodiment, illustrating data under a condition that a Young's modulus of the core material is 40 MPa;

FIG. 8 is a table of structures of a core material of a vacuum insulation panel according to an embodiment, illustrating data under a condition that a Young's modulus of the core material is 50 MPa;

FIG. 9 is a table of structures of a core material of a vacuum insulation panel according to an embodiment, illustrating data under a condition that a Young's modulus of the core material is 60 MPa;

FIG. 10 is a table of structures of a core material of a vacuum insulation panel according to an embodiment, illustrating data under a condition that a Young's modulus of the core material is 70 MPa; and

FIG. 11 is a table of structures of a core material of a vacuum insulation panel according to an embodiment, illustrating data under a condition that a Young's modulus of the core material is 80 MPa.

### DETAILED DESCRIPTION

One or more embodiments of the disclosure and terms used herein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “first”, “second”, “1st”, or “2nd” may be used simply to distinguish a component from other components, without limiting the component in other aspects (e.g., importance or order).

A certain (e.g., a first) component may be referred to as “coupled” or “connected” with or without the terms “functionally” or “communicatively” to another (e.g., second) component. When mentioned, it means that the component can be connected to the other component directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

In the description below, terms such as “front”, “rear”, “left”, “right”, “upper”, “lower”, etc. are defined based on the drawings, and the shapes and positions of the components are not limited by the terms.

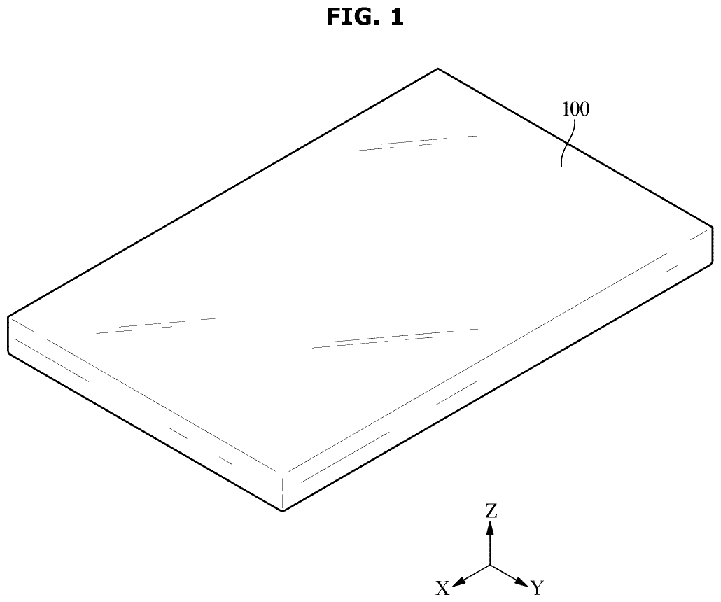

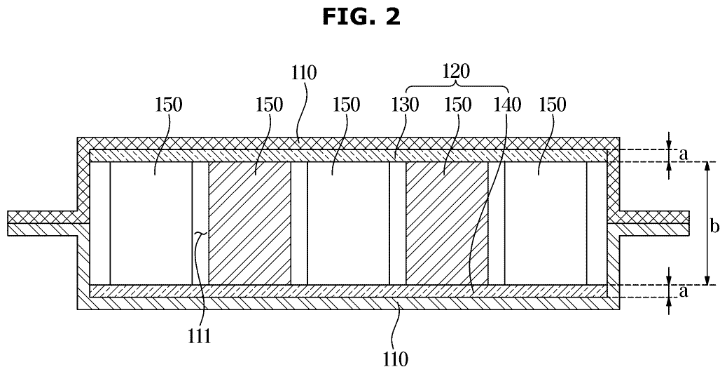

FIG. 1 shows a vacuum insulation panel according to an embodiment. FIG. 2 shows a cross section of a vacuum insulation panel according to an embodiment.

In the disclosure, a Z direction denoted in FIG. 1 is referred to as an up-down direction.

Referring to FIGS. 1 and 2, a vacuum insulation panel 100 may include a covering material (or cover) 110 and a core material (or core structure) 120. The covering material 110 may be positioned on or surround an outer side of the core material 120. The covering material 110 may form an internal space (or accommodating space) 111 which is in a vacuum state, and the core material 120 may be accommodated in the internal space 111. To maintain the internal space 111 in a vacuum state, the covering material 110 may block penetration of a gas and moisture. For example, the covering material 110 may include a moisture and gas blocking film.

The core material 120 may include a first plate 130, a second plate 140, and a supporting member 150.

The first plate 130 may be positioned in the internal space 111 in such a way as to be in contact with a first surface of the covering material 110. For example, the first plate 130 may be positioned in the internal space 111 in such a way as to be in contact with an inner surface of an upper side of the covering material 110.

The second plate 140 may be positioned in the internal space 111 in such a way as to be in contact with a second surface of the covering material 110, which is opposite to the first surface of the covering material 110. For example, the second plate 140 may be positioned in the internal space 111 in such a way as to be in contact with an inner surface of a lower side of the covering member 110.

The first plate 130 may be provided in a shape of a rectangular parallelepiped. For example, the first plate 130 may be in a shape of a rectangular parallelepiped such that each of upper and lower surfaces of the first plate 130 is a square or rectangle. However, the upper and lower surfaces of the first plate 130 may have various shapes, such as a circle, oval, or polygon.

The second plate 140 may have the same or substantially same structure as the first plate 130. To improve productivity, the second plate 140 may have the same structure and material as the first plate 130.

The supporting member 150 may be positioned between the first plate 130 and the second plate 140. The supporting member 150 may be positioned between the first plate 130 and the second plate 140 such that the first plate 130 is spaced from the second plate 140. The supporting member 150 may support the first plate 130 and the second plate 140 such that the first plate 130 is maintained at a preset distance from the second plate 140.

A plurality of supporting members 150 may be provided. The plurality of supporting members 150 may be spaced from each other inside the internal space 111. The plurality of supporting members 150 may be arranged at preset intervals. The preset interval will be described below.

The first plate 130 may be formed of a porous material with a Young's modulus of 30 MPa or more. The second plate 140 may be formed of a porous material with a Young's modulus of 30 MPa or more. The supporting member 150 may be formed of a porous material with a Young's modulus of 30 MPa or more.

The first plate 130 may be formed of a porous material with a Young's modulus of 30 MPa or more to maintain the flatness and structure of the first plate 130 while a pressure is applied to the vacuum insulation panel 100. According to the first plate 130 being formed of a material with a Young's modulus below 30 MPa, the first plate 130 may be deformed by a pressure applied to the vacuum insulation panel 100. For example, in the case in which the first plate 130 is formed of a material with a Young's modulus below 30 MPa and a pressure of 6 atmospheres is applied to an upper surface of the vacuum insulation panel 100, a protrusion corresponding to the shape of the supporting member 150 may be formed on the upper surface of the first plate 130. The protrusion may protrude upward from the upper surface of the first plate 130. By the protrusion, a contact area of the vacuum insulation panel 100 to a target to be insulated may be reduced. Because the protrusion is in contact with the target to be insulated and the upper surface of the first plate 130 except for the protrusion is not in contact with the target to be insulated, a contact area of the first plate 130 to the target to be insulated may be limited to the protrusion. The target to be insulated may be, for example, a partition wall of the refrigerator. A contact of the first plate 130 to the target to be insulated may include a contact of the first plate 130 to the target to be insulated with the covering material 110 in between.

The second plate 140 may be formed of a porous material with a Young's modulus of 30 MPa or more to maintain the flatness and structure of the second plate 140 while a pressure is applied to the vacuum insulation panel 100. According to the second plate 140 being formed of a material with a Young's modulus below 30 MPa, the second plate 140 may be deformed by a pressure applied to the vacuum insulation panel 100. For example, in the case in which the second plate 140 is formed of a material with a Young's modulus below 30 MPa and a pressure of 6 atmospheres is applied to a lower surface of the vacuum insulation panel 100, a protrusion corresponding to the shape of the supporting member 150 may be formed on the lower surface of the second plate 140. The protrusion may protrude downward from the lower surface of the second plate 140. By the protrusion, a contact area of the vacuum insulation panel 100 to a target to be insulated may be reduced. Because the protrusion is in contact with the target to be insulated and the lower surface of the second plate 140 except for the protrusion is not in contact with the target to be insulated, a contact area of the second plate 140 to the target to be insulated may be limited to the protrusion. The target to be insulated may be, for example, a partition wall of the refrigerator. A contact of the second plate 140 to the target to be insulated may include a contact of the second plate 140 to the target to be insulated with the covering material 110 in between.

The supporting member 150 may be formed of a porous material with a Young's modulus of 30 MPa or more to maintain the flatness and structure of the supporting member 150 while a pressure is applied to the vacuum insulation panel 100. According to the supporting member 150 being formed of a material of 30 MPa or less, buckling may occur in the supporting member 150 by a pressure applied to the vacuum insulation panel 100.

According to an embodiment, the first plate 130, the second plate 140, and the third plate 150 may be formed of the same material. However, the first plate 130 and the second plate 140 may be formed of the same material, and the supporting member 150 may be formed of a material that is different from the first plate 130 and the second plate 140.

Also, any one of the first plate 130 or the second plate 140 may be formed of the same material as the supporting member 150, and another one may be formed of a material that is different from the supporting member 150.

The first plate 130, the second plate 140, and the supporting member 150 may include at least one of glass wool, expanded cork, or polyurethane.

Referring to FIG. 2, the first plate 130 may have a thickness (first thickness) of a. The second plate 140 may have the same thickness of a as the thickness of the first plate 130. The supporting member 150 may have a thickness (second thickness) of b that is greater than a. The core material 120 except for the covering material 110 may have a thickness of T. The thickness T of the core material 120, the thickness a of the first plate 130 or the second plate 140, and the thickness b of the supporting member 150 may satisfy T=2*a+b.

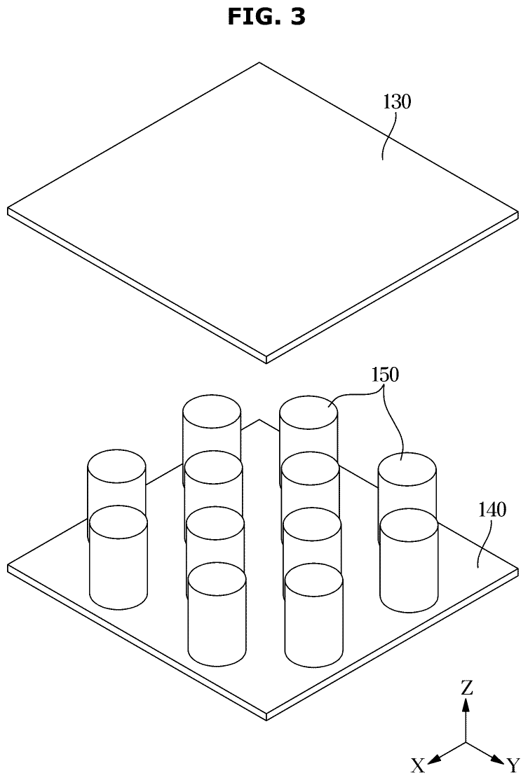

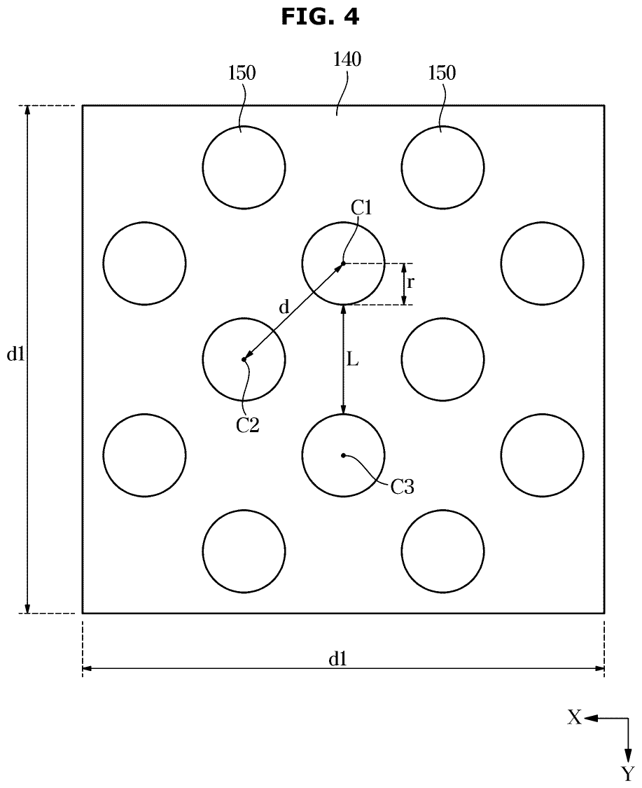

FIG. 3 illustrates an example of a core material of a vacuum insulation panel according to an embodiment. FIG. 4 illustrates a supporting member and a second plate in the core material shown in FIG. 3, at another angle.

Referring to FIG. 3, the supporting member 150 according to an embodiment may be in a shape of a cylinder. The plurality of supporting members 150 may be arranged on the second plate 140 in such a way as to be spaced from each other. The first plate 130 may be positioned on the plurality of supporting members 150. However, the plurality of supporting members 150 may be arranged on the first plate 130 in such a way as to be spaced from each other, and the second plate 140 may be positioned on the plurality of supporting members 150.

Referring to FIG. 4, the supporting member 150 being in the shape of the cylinder may have a radius of r. A distance between centers of two supporting members located at a close distance among four supporting members adjacent to each other may be d. A distance between centers of two supporting members located at a long distance among four supporting members adjacent to each other may be 2*r+L. In other words, a distance between a first center C1 of a first supporting member 150 and a second center C2 of a second supporting member 150 positioned at a close distance among four supporting members adjacent to each other may be d. A distance between the first center C1 of the first supporting member 150 and a third center C3 of a third supporting member 150 located at a long distance among the four supporting members may be 2*r+L. Hereinafter, L may be a maximum distance between two supporting members 150.

A center of each of four supporting members adjacent to each other may be positioned to correspond to each vertex of a square. Accordingly, d, r, and L may satisfy √2*d=2*r+L.

The supporting member 150 may be in a shape of a polyprism, instead of a cylinder. The plurality of supporting members 150 may be arranged on the second plate 140 in such a way as to be spaced from each other. The first plate 130 may be positioned on the plurality of supporting members 150. However, the plurality of supporting members 150 may be arranged on the first plate 130 in such a way as to be spaced from each other, and the second plate 140 may be positioned on the plurality of supporting members 150.

Also, a part of the plurality of supporting members 150 may be in a shape of a cylinder, and the remaining part of the plurality of supporting members 150 may be in a shape of a polyprism. The plurality of supporting members 150 being in the shape of the polyprism may have the same shape or different shapes.

According to the supporting member 150 being in a shape of a polyprism, an area of a polygon being a cross section of the polyprism may be π*r\hat{ }2. In other words, a cross-sectional area of the supporting member 150 being in a shape of a cylinder may be equal to a cross-sectional area of the supporting member 150 being in a shape of a polyprism. In this case, a distance from a center of the polygon being the cross section of the polyprism to a farthest location from the center on the polygon may be r. For example, a distance from the center of the polygon being the cross section of the polyprism to a vertex of the polygon may be r. According to the supporting member 150 being in a shape of a polyprism, the distance r from the center of the polygon to the farthest location may be substituted into √2*d=2*r+L.

Referring to FIG. 4, each of the first plate 130 and the second plate 140 may be in shape of a rectangular parallelepiped of which the upper and lower surfaces are squares. A length of one side of each square may be d1. Accordingly, the upper or lower surface of each of the first plate 130 and the second plate 140 may have an area of d1\hat{ }2. Hereinafter, an area of the first plate 130 may be an area of the upper or lower surface of the first plate 130. An area of the second plate 140 may be an area of the upper or lower surface of the second plate 140. An area of the supporting members 150 may be a sum of areas of the upper or lower surfaces of the plurality of supporting members 150. Hereinafter, the area of the first plate 130 or the second plate 140 is referred to as S1. The area of the supporting members 150 is referred to as S2.

As described above, the area of the first plate 130 may be d1\hat{ }2, and the area of the second plate 140 may also be d1\hat{ }2 that is equal to the area of the first plate 130. The area of the supporting members 150 may be n (the number of the plurality of supporting members 150)*π*r\hat{ }2. A ratio of the area of the supporting members 150 with respect to the area of the first plate 130 or the area of the second plate 140 is referred to as x. That is, x=(n*π*r\hat{ }2)/d1\hat{ }2.

Hereinafter, a process for setting the thickness a of the first plate 130 and the second plate 140, the thickness b of the supporting member 150, the radius r of the supporting member 150, the total thickness T of the core material 120, the ratio x of the area of the supporting members 150 with respect to the area of the first plate 130 or the area of the second plate 140, and the maximum distance L between two supporting members in the core material 120 according to the disclosure will be described in detail.

As described above, the supporting member 150 may be in a shape of a cylinder. According to the supporting member 150 being in a shape of a cylinder, a buckling limit of the supporting member 150 may be calculated by Equation below.

$$F = ( π \hat{} 2 * E * I ) / ( k * b ) \hat{} 2 ,$$

where E represents a Young's modulus of the supporting member 150, I represents a secondary moment of inertia of the circle, k represents an effective length factor, and F represents a critical load of buckling. The secondary moment I of inertia of the circle having the radius r may be I=(π*r\hat{ }4)/4. Under an assumption that both edges of the cylinder are fixed, k=0.5 (fixed edges). According to a pressure P being applied to the upper surface of the supporting member 150, the critical load F of buckling may be F=π*r\hat{ }2*P.

Under an assumption that a static long term load is applied to the vacuum insulation panel 100, a factor of safety of 4 may be applied. A load of 1.5 atmospheres may be applied to the vacuum insulation panel 100. As a result of applying the factor of safety of 4 to the 1.5 atmospheres, P may become 6 atmospheres (atm). According to P being greater than 240 MPa, yield may occur, and according to P being smaller than 240 MPa, buckling may occur. Because 6 atm is substantially 0.6 MPa, only buckling may be considered.

By substituting I and F into F=(π\hat{ }2*E*I)/(k*b)\hat{ }2 and organizing the substituted result for r, r=(2*k*b)/π*(P/E) \hat{ }0.5. By substituting k=0.5 into r=(2*k*b)/π*(P/E) \hat{ }0.5, r=b/π*(P/E) \hat{ }0.5, wherein r is a minimum radius with which the supporting members 150 are not buckled.

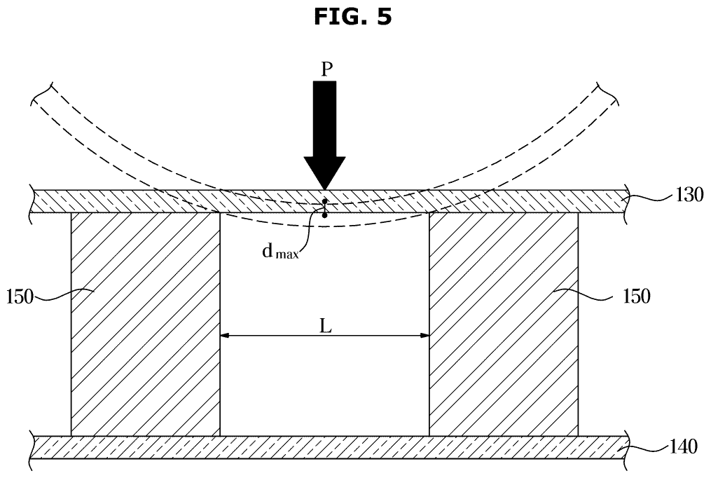

FIG. 5 conceptually illustrates beam deflection of a first plate while a pressure is applied to a core material of a vacuum insulation panel according to an embodiment.

Referring to FIG. 5, while a pressure P is applied to the core material 120, beam deflection of the first plate 130 may be dₘₐₓ, and dₘₐₓ may satisfy Equation below.

$${d}_{max} = ( 5 * q * L \hat{} 4 ) / ( 384 * E * I ) ,$$

where E represents a Young's modulus of the first plate 130, I represents a secondary moment of inertia of a rectangle, and q represents a load per unit length. A secondary moment I of inertia of a rectangle having a width L and a height H may be I=(L*a\hat{ }3)/12. q=P*L\hat{ }2/L.

By substituting I and q into dₘₐₓ=(5*q*L\hat{ }4)/(384*E*I) and organizing the substituted result for L, L=((384*dₘₐₓ*E*a\hat{ }3)/(60*P)) \hat{ }0.25. L may be a maximum distance between two supporting members 150 to maintain the structure and flatness of the first plate 130. dₘₐₓ may be set to 0.5 mm in consideration of the thickness of a normal vacuum insulation panel.

Thermal conductivity Kₜₒₜₐₗ of the core material 120 including the first plate 130, the second plate 140, and the supporting members 150 may be derived according to Equation below.

$${K}_{total} = ( 2 * a + b ) / ( ( 2 * a / {K}_{c} ) + ( b / ( {K}_{c} * x + b / ( {K}_{c} * x + {K}_{v} * ( 1 - x ) ) ) ) ) ) ,$$

where K_{c} represents thermal conductivity of a material constituting the core material 120, Kᵥ represents thermal conductivity of vacuum, and Kᵥ is assumed to be 1 mW/m·K.

Thermal resistance of the first plate 130 and the second plate 140 is Rₒ, and thermal resistance of the support member 150 is R_{c}. While total thermal resistance of an intermediate layer between the first plate 130 and the second plate 140 is R′, 1/R′=1/R_{c}+1/Rᵥ may be satisfied under an assumption that the supporting members 150 are connected in parallel to vacuum. Rᵥ may be thermal resistance of vacuum.

Total thermal resistance Rₜₒₜₐₗ of the core material 120 may be obtained by Equation Rₜₒₜₐₗ=Rₒ+R′+Rₒ under an assumption that thermal resistances of the first plate 130, the second plate 140, and the intermediate layer between the first plate 130 and the second plate 140 are connected in serial to each other.

As a result of deriving thermal conductivity of the vacuum insulation panel 100 according to the disclosure through the above Equation, thermal conductivity of the core material 120 may be between 1.442 mW/m·K and 1.876 mW/m·K. More specifically, under a condition that the core material 120 is formed of glass wool and has a thickness of 20 mm, thermal conductivity of the core material 120 may be 1.442 mW/m·K. Under a condition that the core material 120 is formed of glass wool and has a thickness of 30 mm, thermal conductivity of the core material 120 may be 1.478 mW/m·K. Under a condition that the core material 120 is formed of expanded cork and has a thickness of 20 mm, thermal conductivity of the core material 120 may be 1.806 mW/m·K. Under a condition that the core material 120 is formed of expanded cork and has a thickness of 30 mm, thermal conductivity of the core material 120 may be 1.876 mW/m·K.

Thermal conductivity of an existing vacuum insulation panel including an unstructured single plate-shaped core material may be 4 mW/m·K in the case in which the core material is formed of glass wool, and 7 mW/m·K in the case in which the core material is formed of expanded cork.

Accordingly, the vacuum insulation panel 100 according to the disclosure may have thermal conductivity that is less than 50% of the thermal conductivity of the existing vacuum insulation panel.

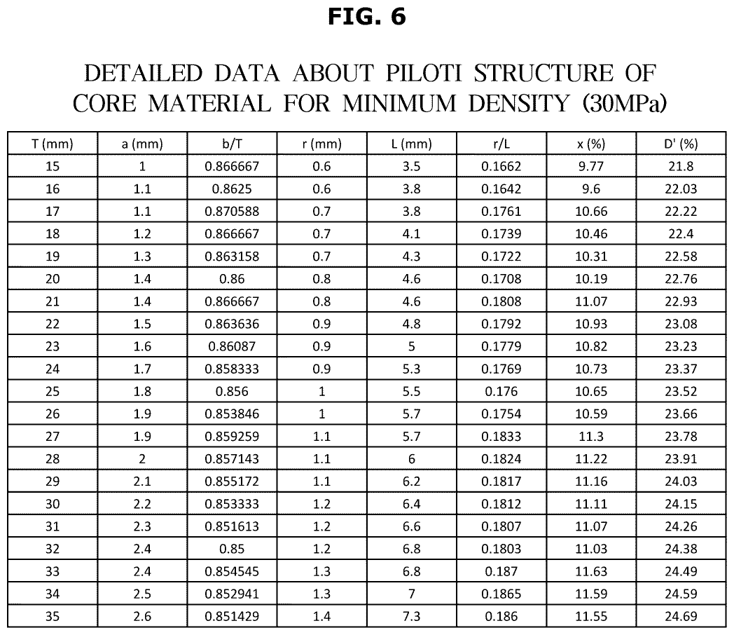

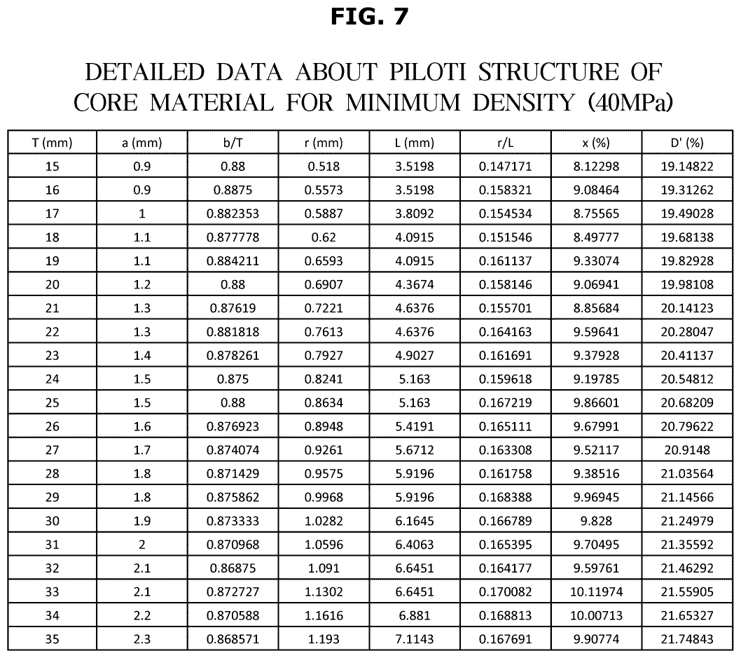

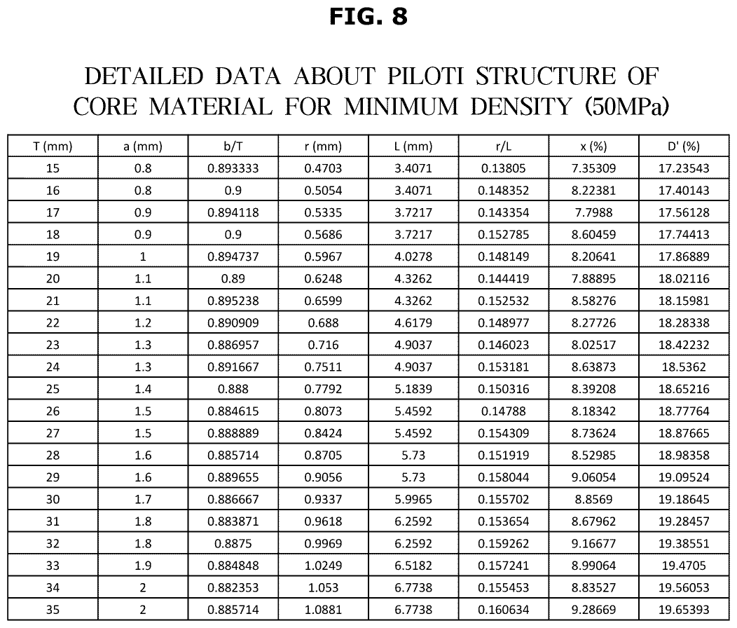

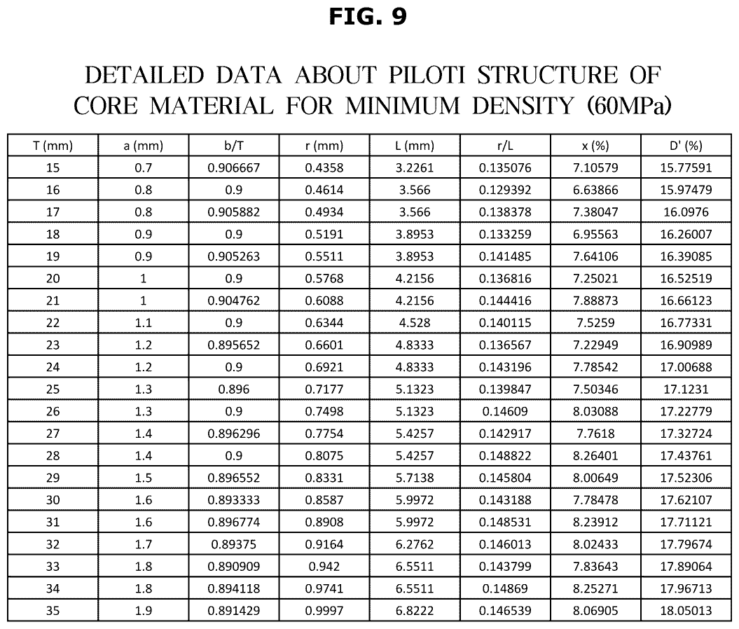

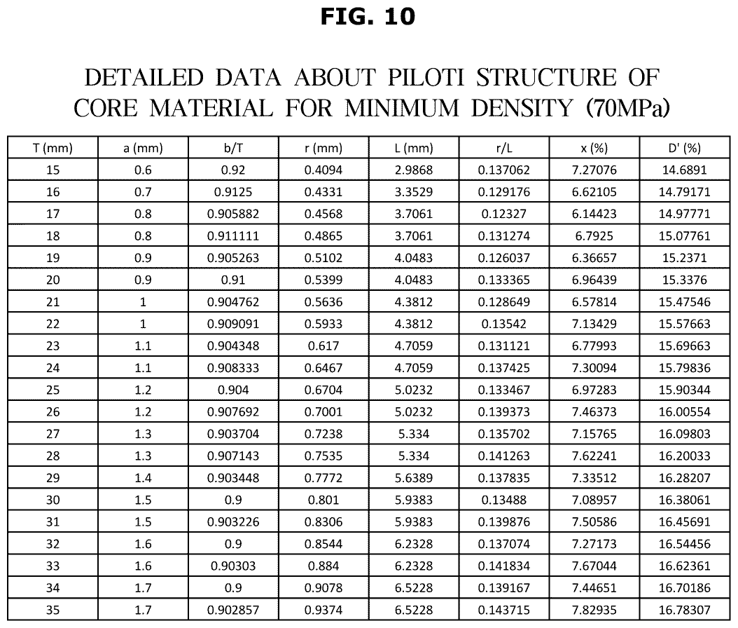

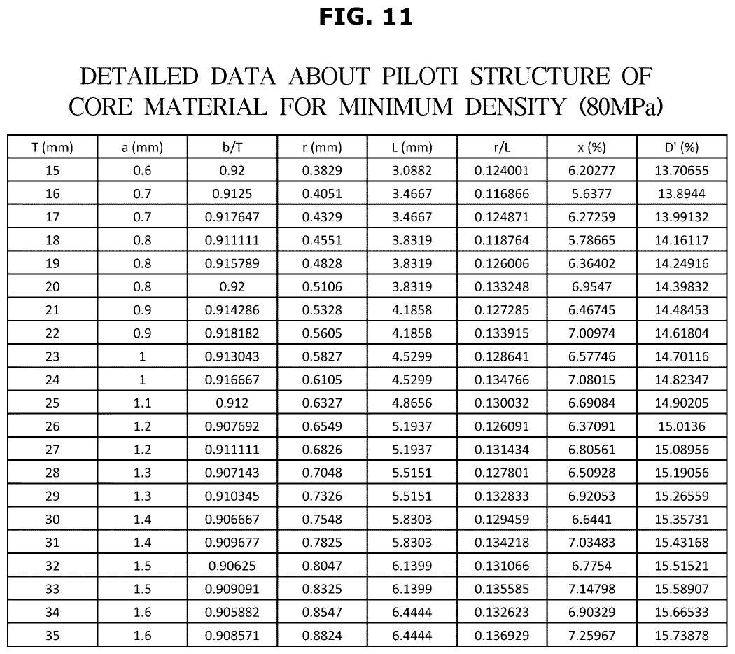

FIG. 6 is a table of structures of a core material of a vacuum insulation panel according to an embodiment, illustrating data under a condition that a Young's modulus of the core material is 30 MPa. FIG. 7 is a table of structures of a core material of a vacuum insulation panel according to an embodiment, illustrating data under a condition that a Young's modulus of the core material is 40 MPa. FIG. 8 is a table of structures of a core material of a vacuum insulation panel according to an embodiment, illustrating data under a condition that a Young's modulus of the core material is 50 MPa. FIG. 9 is a table of structures of a core material of a vacuum insulation panel according to an embodiment, illustrating data under a condition that a Young's modulus of the core material is 60 MPa. FIG. 10 is a table of structures of a core material of a vacuum insulation panel according to an embodiment, illustrating data under a condition that a Young's modulus of the core material is 70 MPa. FIG. 11 is a table of structures of a core material of a vacuum insulation panel according to an embodiment, illustrating data under a condition that a Young's modulus of the core material is 80 MPa.

In the tables of FIGS. 6 to 11, T represents the thickness of the core material 120, a represents the thickness of the first plate 130 or the thickness of the second plate 140, and b represents the thickness of the supporting member 150. r represents the radius of the supporting member 150 being in a shape of a cylinder or a maximum distance from the center of the supporting member 150 being in a shape of a polyprism. L represents a maximum distance between two supporting members 150. x represents the ratio of the area of the supporting members 150 with respect to the area of the first plate 130 or the area of the second plate 140 in percent units. D′ represents a density of the core material 120 according to the disclosure with respect to a density of a core material having an existing structure in percent units. In FIGS. 6 to 11, the density of the core material having the existing structure is assumed to be 160 kg/m³.

Referring to FIGS. 6 to 11, by structuring the core material 120 into the structure according to the disclosure as described above with reference to examples of FIGS. 1 to 4 by using a porous material with a Young's modulus of 30 MPa, a density of the core material 120 may be reduced by 75% or more compared to the existing core material. The existing core material may be a core material provided in a shape of a compressed rectangular parallelepiped without having any special structure. In other words, the existing core material may be a core material provided in a single plate structure.

Referring to FIG. 6, by structuring the core material 120 into the structure according to the disclosure as described above with reference to examples of FIGS. 1 to 4 by using a porous material with a Young's modulus of 30 MPa, a density of the core material 120 may be reduced by 75.31% to 78.20% compared to the structure of the existing core material according to the thickness of the core material 120 ranging from 15 mm to 35 mm.

Referring to FIG. 7, by structuring the core material 120 into the structure according to the disclosure as described above with reference to the examples of FIGS. 1 to 4 by using a porous material with a Young's modulus of 40 MPa, a density of the core material 120 may be reduced by 78.25% to 80.85% compared to the structure of the existing core material, according to the thickness of the core material 120 ranging from 15 mm to 35 mm.

Referring to FIG. 8, by structuring the core material 120 into the structure according to the disclosure as described above with reference to the examples of FIGS. 1 to 4 by using a porous material with a Young's modulus of 50 MPa, a density of the core material 120 may be reduced by 80.35% to 82.76% compared to the structure of the existing core material, according to the thickness of the core material 120 ranging from 15 mm to 35 mm.

Referring to FIG. 9, by structuring the core material 120 into the structure according to the disclosure as described above with reference to the examples of FIGS. 1 to 4 by using a porous material with a Young's modulus of 60 MPa, a density of the core material 120 may be reduced by 81.95% to 84.22% compared to the structure of the existing core material, according to the thickness of the core material 120 ranging from 15 mm to 35 mm.

Referring to FIG. 10, by structuring the core material 120 into the structure according to the disclosure as described above with reference to the examples of FIGS. 1 to 4 by using a porous material with a Young's modulus of 70 MPa, a density of the core material 120 may be reduced by 83.22% to 85.31% compared to the structure of the existing core material, according to the thickness of the core material 120 ranging from 15 mm to 35 mm.

Referring to FIG. 11, by structuring the core material 120 into the structure according to the disclosure as described above with reference to the examples of FIGS. 1 to 4 by using a porous material with a Young's modulus of 80 MPa, a density of the core material 120 may be reduced by 84.26% to 86.29% compared to the structure of the existing core material, according to the thickness of the core material 120 ranging from 15 mm to 35 mm.

As described above, a density of the vacuum insulation panel 100 including the structured core material 120 according to the disclosure may be reduced by 75% or more compared to the vacuum insulation panel including the existing core material with the single plate structure. Accordingly, although a thickness of a structure in which the vacuum insulation panel 100 is installed is reduced, no structural load may be applied to the structure. For example, in the case in which the vacuum insulation panel 100 is installed in a partition wall of a refrigerator, no physical load may be applied to the partition wall although a thickness of the partition wall is reduced in parallel to a reduction in thickness of the vacuum insulation panel 100. That is, the partition wall of the refrigerant may be maintained in a structurally stable state.

Referring to FIGS. 6 to 11, in the case of structuring the core material 120 into the structure according to the disclosure as described above with reference to the examples of FIGS. 1 to 4 by using a porous material with a Young's modulus of 30 MPa, the thickness b of the supporting member 150 may be within a range of 85.00% to 92.00% of the thickness T of the core material 120.

Referring to FIG. 6, in the case of structuring the core material 120 into the structure according to the disclosure as described above with reference to the examples of FIGS. 1 to 4 by using a porous material with a Young's modulus of 30 MPa, the thickness b of the supporting member 150 may be within a range of 85.00% to 87.06% of the thickness T of the core material 120 which ranges from 15 mm to 35 mm.

Referring to FIG. 7, in the case of structuring the core material 120 into the structure according to the disclosure as described above with reference to the examples of FIGS. 1 to 4 by using a porous material with a Young's modulus of 40 MPa, the thickness b of the supporting member 150 may be within a range of 86.86% to 88.75% of the thickness T of the core material 120 which ranges from 15 mm to 35 mm.

Referring to FIG. 8, in the case of structuring the core material 120 into the structure according to the disclosure as described above with reference to the examples of FIGS. 1 to 4 by using a porous material with a Young's modulus of 50 MPa, the thickness b of the supporting member 150 may be within a range of 88.24% to 90.00% of the thickness T of the core material 120 which ranges from 15 mm to 35 mm.

Referring to FIG. 9, in the case of structuring the core material 120 into the structure according to the disclosure as described above with reference to the examples of FIGS. 1 to 4 by using a porous material with a Young's modulus of 60 MPa, the thickness b of the supporting member 150 may be within a range of 89.09% to 90.67% of the thickness T of the core material 120 which ranges from 15 mm to 35 mm.

Referring to FIG. 10, in the case of structuring the core material 120 into the structure according to the disclosure as described above with reference to the examples of FIGS. 1 to 4 by using a porous material with a Young's modulus of 70 MPa, the thickness b of the supporting member 150 may be within a range of 90.00% to 92.00% of the thickness T of the core material 120 which ranges from 15 mm to 35 mm.

Referring to FIG. 11, in the case of structuring the core material 120 into the structure according to the disclosure as described above with reference to the examples of FIGS. 1 to 4 by using a porous material with a Young's modulus of 80 MPa, the thickness b of the supporting member 150 may be within a range of 90.59% to 92.00% of the thickness T of the core material 120 which ranges from 15 mm to 35 mm.

Referring to FIGS. 6 to 11, in the case of structuring the core material 120 into the structure according to the disclosure as described above with reference to the examples of FIGS. 1 to 4 by using a porous material with a Young's modulus of 30 MPa, a ratio of an area of the supporting members 150 with respect to an area of the first plate 130 or the second plate 140 may be within a range of 5.64% to 11.60%.

Referring to FIG. 6, in the case of structuring the core material 120 into the structure according to the disclosure as described above with reference to the examples of FIGS. 1 to 4 by using a porous material with a Young's modulus of 30 MPa, a ratio of an area of the supporting members 150 with respect to an area of the first plate 130 or the second plate 140 may be within a range of 9.60% to 11.63% according to the thickness of the core material 120 ranging from 15 mm to 35 mm.

Referring to FIG. 7, in the case of structuring the core material 120 into the structure according to the disclosure as described above with reference to the examples of FIGS. 1 to 4 by using a porous material with a Young's modulus of 40 MPa, a ratio of an area of the supporting members 150 with respect to an area of the first plate 130 or the second plate 140 may be within a range of 8.12% to 10.12% according to the thickness of the core material 120 ranging from 15 mm to 35 mm.

Referring to FIG. 8, in the case of structuring the core material 120 into the structure according to the disclosure as described above with reference to the examples of FIGS. 1 to 4 by using a porous material with a Young's modulus of 50 MPa, a ratio of an area of the supporting members 150 with respect to an area of the first plate 130 or the second plate 140 may be within a range of 7.35% to 9.29% according to the thickness of the core material 120 ranging from 15 mm to 35 mm.

Referring to FIG. 9, in the case of structuring the core material 120 into the structure according to the disclosure as described above with reference to the examples of FIGS. 1 to 4 by using a porous material with a Young's modulus of 60 MPa, a ratio of an area of the supporting members 150 with respect to an area of the first plate 130 or the second plate 140 may be within a range of 6.64% to 8.26% according to the thickness of the core material 120 ranging from 15 mm to 35 mm.

Referring to FIG. 10, in the case of structuring the core material 120 into the structure according to the disclosure as described above with reference to the examples of FIGS. 1 to 4 by using a porous material with a Young's modulus of 70 MPa, a ratio of an area of the supporting members 150 with respect to an area of the first plate 130 or the second plate 140 may be within a range of 6.14% to 7.83% according to the thickness of the core material 120 ranging from 15 mm to 35 mm.

Referring to FIG. 11, in the case of structuring the core material 120 into the structure according to the disclosure as described above with reference to the examples of FIGS. 1 to 4 by using a porous material with a Young's modulus of 80 MPa, a ratio of an area of the supporting members 150 with respect to an area of the first plate 130 or the second plate 140 may be within a range of 5.64% to 7.26% according to the thickness of the core material 120 ranging from 15 mm to 35 mm.

As described above, referring to FIG. 4, a distance d between centers of two supporting members 150 positioned at a close distance, a radius r of each supporting member 150, and a distance L between two supporting members 150 positioned at a long distance may satisfy √2*d=2*r+L. As a result of organizing √2*d=2*r+L into a relationship of d and r, d=1/√2*(2+L/r)*r.

As a result of substituting the reciprocal of r/L shown in FIGS. 6 to 11 into the relationship, a distance d between centers of two supporting members 150 positioned at a close distance and a radius r of each supporting member 150 in the case of structuring the core material 120 into the structure according to the disclosure as described above with reference to the examples of FIGS. 1 to 4 by using a porous material with a Young's modulus of 30 MPa may be within a range of 5.20*r≤d≤7.46*r.

Referring to FIG. 6, in the case of structuring the core material 120 into the structure according to the disclosure as described above with reference to the examples of FIGS. 1 to 4 by using a porous material with a Young's modulus of 30 MPa, a distance d between centers of two supporting members 150 positioned at a close distance and a radius r of each supporting member 150 may be within a range of 5.20*r≤d≤5.67*r according to a thickness of the core material 120 ranging from 15 mm to 35 mm.

Referring to FIG. 7, in the case of structuring the core material 120 into the structure according to the disclosure as described above with reference to the examples of FIGS. 1 to 4 by using a porous material with a Young's modulus of 40 MPa, a distance d between centers of two supporting members 150 positioned at a close distance and a radius r of each supporting member 150 may be within a range of 5.57*r≤d≤6.22*r according to a thickness of the core material 120 ranging from 15 mm to 35 mm.

Referring to FIG. 8, in the case of structuring the core material 120 into the structure according to the disclosure as described above with reference to the examples of FIGS. 1 to 4 by using a porous material with a Young's modulus of 50 MPa, a distance d between centers of two supporting members 150 positioned at a close distance and a radius r of each supporting member 150 may be within a range of 5.81*r≤d≤6.54*r according to a thickness of the core material 120 ranging from 15 mm to 35 mm.

Referring to FIG. 9, in the case of structuring the core material 120 into the structure according to the disclosure as described above with reference to the examples of FIGS. 1 to 4 by using a porous material with a Young's modulus of 60 MPa, a distance d between centers of two supporting members 150 positioned at a close distance and a radius r of each supporting member 150 may be within a range of 6.16*r≤d≤6.90*r according to a thickness of the core material 120 ranging from 15 mm to 35 mm.

Referring to FIG. 10, in the case of structuring the core material 120 into the structure according to the disclosure as described above with reference to the examples of FIGS. 1 to 4 by using a porous material with a Young's modulus of 30 MPa, a distance d between centers of two supporting members 150 positioned at a close distance and a radius r of each supporting member 150 may be within a range of 6.32*r≤d≤7.16*r according to a thickness of the core material 120 ranging from 15 mm to 35 mm.

Referring to FIG. 11, in the case of structuring the core material 120 into the structure according to the disclosure as described above with reference to the examples of FIGS. 1 to 4 by using a porous material with a Young's modulus of 30 MPa, a distance d between centers of two supporting members 150 positioned at a close distance and a radius r of each supporting member 150 may be within a range of 6.58*r≤d≤7.46*r according to a thickness of the core material 120 ranging from 15 mm to 35 mm.

In summary, according to the core material 120 being formed of a porous material with a Young's modulus of 30 MPa, a density may be reduced by 75% or more compared to the density 160 kg/m³ of the existing vacuum insulation panel. According to the core material 120 being formed of a porous material with a Young's modulus of 30 MPa or more, because a density reduction rate tends to increase gradually, a density may be reduced by 75% or more compared to the existing vacuum insulation panel, according to the thickness of the core material 120 ranging from 15 mm to 35 mm, even with a Young's modulus of 90 MPa, although not shown in FIGS. 6 to 11. That is, the critical point of the Young's modulus of the porous material for forming the structured core material 120 according to the disclosure as described above with reference to the examples of FIGS. 1 to 4 may be 30 MPa.

According to an embodiment, a vacuum insulation panel may include a core material, and a covering material positioned on an outer side of the core material to form an accommodating space in which the core material is accommodated. The core material may include a first plate having a first thickness, including a porous material with a Young's modulus of 30 MPa or more, and positioned in the accommodating space, a second plate having the first thickness, including a porous material with a Young's modulus of 30 MPa or more and positioned in the accommodating space while being spaced from the first plate, and a supporting member having a second thickness that is greater than the first thickness, including a porous material with a Young's modulus of 30 MPa or more, and positioned between the first plate and the second plate such that the first plate is spaced from the second plate. A surface of the first plate positioned perpendicular to a thickness direction of the core material may have a first area, a surface of the second plate positioned perpendicular to the thickness direction may have the first area, and a surface of the supporting member positioned perpendicular to the thickness direction may have a second area that is smaller than the first area.

The first thickness may be a, the second thickness may be b, and the first thickness and the second thickness may satisfy (2a+b)*85%≤b≤(2a+b)*92.0%.

The first area may be S1, the second area may be S2, and the first area and the second area may satisfy S1*5.64%≤S2≤S1*11.60%.

A density of the core material may be less than 40 kg/m³.

A plurality of supporting members may be provided, and each of the plurality of supporting members may be in a shape of a cylinder with a radius of r.

A minimum distance between centers of two supporting members adjacent to each other among the plurality of supporting members may be d that satisfies 5.20*r≤d≤7.46*r.

A maximum distance between centers of two supporting members adjacent to each other among the plurality of supporting members may be L that satisfies 0.12≤r/L≤0.19.

While a pressure of 6 atmospheres (atm) is applied to the first plate or the second plate, maximum beam deflection of the first plate or the second plate may be 0.5 mm or less.

The supporting member may be in a shape of a polyprism.

An area of a polygon being a cross section of the polyprism may be π*r\hat{ }2.

A maximum distance of the polygon from a center of the polygon may be r.

At least two or more of the first plate, the second plate, and the supporting member may be formed of the same material.

The first plate, the second plate, and the supporting member may include at least one of glass wool, expanded cork, or polyurethane.

The accommodating space may be in a vacuum state.

Example embodiments have been shown and described. However, the disclosure is not limited to the above-described embodiments, and various modifications can be made by those skilled in the art without departing from the gist of the technical idea of the disclosure defined by the claims below.

What is claimed is:

1. A vacuum insulation panel comprising:
a core material; and
a covering material on an outer side of the core material and forming an internal space in which the core material is accommodated,
wherein the core material comprises:
a first plate in the internal space and having a first thickness, the first plate comprising a first porous material with a Young's modulus of at least 30 megapascals (MPa);
a second plate in the internal space, spaced from the first plate, and having the first thickness, the second plate comprising a second porous material with a Young's modulus of at least 30 MPa; and
at least one supporting member between the first plate and the second plate and having a second thickness that is greater than the first thickness, the at least one supporting member comprising a third porous material with a Young's modulus of at least 30 MPa,
wherein each of a surface of the first plate that is perpendicular to a thickness direction of the core material and a surface of the second plate that is perpendicular to the thickness direction has a first area, and
wherein a surface of the at least one supporting member that is perpendicular to the thickness direction has a second area that is smaller than the first area.

2. The vacuum insulation panel of claim 1, wherein the first thickness is a, the second thickness is b, and the first thickness and the second thickness satisfy (2a+b)*85%≤b≤(2a+b)*92.0%.

3. The vacuum insulation panel of claim 1, wherein the first area is S1, the second area is S2, and the first area and the second area satisfy S1*5.64%≤S2≤S1*11.60%.

4. The vacuum insulation panel of claim 1, wherein a density of the core material is less than 40 kg/m3.

5. The vacuum insulation panel of claim 1, wherein the at least one supporting member comprises a plurality of supporting members, and each of the plurality of supporting members has a shape of a cylinder with a radius of r.

6. The vacuum insulation panel of claim 5, wherein a minimum distance between centers of two supporting members positioned adjacent to each other among the plurality of supporting members is d and satisfies 5.20*r≤d≤7.46*r.

7. The vacuum insulation panel of claim 5, wherein a maximum distance between centers of two supporting members positioned adjacent to each other among the plurality of supporting members is L and satisfies 0.12≤r/L≤0.19.

8. The vacuum insulation panel of claim 1, wherein, while a pressure of 6 atmospheres is applied to the first plate or the second plate, a maximum beam deflection of the first plate or the second plate is less than or equal to 0.5 mm.

9. The vacuum insulation panel of claim 1, wherein the at least one supporting member has a shape of a polyprism,
wherein an area of a polygon that is a cross section of the polyprism is π*r\hat{ }2, and
wherein a maximum distance of an edge of the polygon from a center of the polygon is r.

10. The vacuum insulation panel of claim 1, wherein at least two of the first plate, the second plate, and the at least one supporting member comprise a same material.

11. The vacuum insulation panel of claim 10, wherein each of the first plate, the second plate, and the at least one supporting member comprises at least one of glass wool, expanded cork, or polyurethane.

12. The vacuum insulation panel of claim 1, wherein the internal space is in a vacuum state.

13. An insulation panel comprising:
a core structure comprising:
a first plate having a first thickness, the first plate comprising a first porous material;
a second plate having the first thickness, the second plate comprising a second porous material; and
a plurality of supporting members spaced apart from each other and interposed between the first plate and the second plate, the plurality of supporting members having a second thickness that is greater than the first thickness and comprising a third porous material; and
a cover surrounding the core structure in a vacuum state, and
wherein each of a surface of the first plate that is perpendicular to a thickness direction of the core structure and a surface of the second plate that is perpendicular to the thickness direction has a first area, and a surface of the supporting member that is perpendicular to the thickness direction has a second area that is smaller than the first area.

14. The insulation panel of claim 13, wherein the cover comprises a film that blocks moisture and gas.

15. The insulation panel of claim 13, wherein each of the first porous material, the second porous material, and the third porous material have a Young's modulus of at least 30 megapascals (MPa).

16. The insulation panel of claim 13, wherein each of the first porous material, the second porous material, and the third porous material have a Young's modulus of at least 40 megapascals (MPa).

17. The insulation panel of claim 13, wherein each of the first porous material, the second porous material, and the third porous material have a Young's modulus of at least 50 megapascals (MPa).

18. The insulation panel of claim 13, wherein each of the first porous material, the second porous material, and the third porous material have a Young's modulus of at least 60 megapascals (MPa).

19. The insulation panel of claim 13, wherein each of the first porous material, the second porous material, and the third porous material have a Young's modulus of at least 70 megapascals (MPa).

20. The insulation panel of claim 13, wherein each of the first porous material, the second porous material, and the third porous material have a Young's modulus of at least 80 megapascals (MPa).
